(19) United States
(12) Patent Application Publication
(10) Pub. No.: US 2009/0003320 A1
(43) Pub. Date: Jan. 1, 2009

(54) System for seamless redundancy in IP communication network

(76) Inventors: Yun Feng (Mason) Luo, QingDao (CN); Aden Bin Yang, QingDao (CN); Li (Jerry) Nie, QingDao (CN)

Correspondence Address: MCCORMICK, PAULDING & HUBER LLP, 185 ASYLUM STREET, CITY PLACE II, HARTFORD, CT, 06103, US

(21) Appl. No.: 11/900,465

(22) Filed: Sep. 12, 2007

(30) Foreign Application Priority Data
Jun. 29, 2007 (CN) 200710112270.1

(51) Int. Cl. H04L 12/66

(52) U.S. Cl. 370/352

(57) ABSTRACT

In a seamless redundancy or failover system for an IP network, data intended for a master component is received at a seamless redundancy component, where the data is routed both to the master component and to a standby component. The standby component is configured to process the data in the same manner as the master component, e.g., the standby component may be a duplicate of the master component, or another component configured to perform the same data processing functions. For seamless redundancy/failover, the data output of the standby component is suppressed unless and until the master component enters a failure condition, at which time the data output of the standby component is enabled for transmission to a downstream network component. “Failure condition” refers to an operational state of the master component where the master component is unable to process received data in its intended and normal manner.

This application is entitled to the benefit of and claims foreign priority under 35 U.S.C. § 119 from Chinese Patent Application No. 200710112270.1, filed Jun. 29, 2007, the disclosure of which is hereby incorporated by reference.

### FIELD OF THE INVENTION

The present invention relates to communication systems and, more particularly, to redundancy mechanisms in an IP-based network or other communication environment.

### BACKGROUND OF THE INVENTION

In telecommunication systems such as IMS (IP multimedia subsystem) networks and other IP-based packet data networks, it is important to achieve a high degree of component/node stability, in order to maintain sufficient levels of data throughput, guaranteed quality of service levels, and the like. Stability can be increased by eliminating or reducing conditions of data transmission slowdown during periods of component failure or down time. For this purpose, many communication systems include an “n+m” redundancy mechanism, that is, there are “n” active nodes and “m” shared standby nodes for all of the “n” active nodes. For example, in a 1+1 redundancy environment, data is synchronized between the master machine/element and the standby element so that the standby machine can take over in case the master element goes into a shutdown or fail mode for one reason or another. However, in very high traffic network environments, it may the case that not all data is synchronized timely from the master element to the standby element. In such cases, only the most important data is synchronized, meaning that information is lost or significantly delayed during switchover, thereby resulting in low levels of network stability.

Furthermore, most communication networks have a large number of components. For “n+m” redundancy or otherwise, each component may be provided with its own redundancy mechanism. Considering that the redundancy mechanisms perform generally the same function, and are typically designed and configured in generally the same manner, this results in duplicative development efforts and wasted processing resources.

### SUMMARY OF THE INVENTION

An embodiment of the present invention relates to a method of processing data in a network, as part of a seamless redundancy or failover system in an IP (Internet protocol) or other packet data network. Data intended for a master component is received at a seamless redundancy component, where the data is routed both to the master component and to a standby component. (By “component,” it is meant electronic hardware and/or software configured to process data for network communication purposes.) The standby component is configured to process the data in substantially the same manner as the master component, e.g., the standby component may be a duplicate of the master component, or another component configured to perform the same data processing functions as the master component. The data output of the standby component (e.g., data output=f{data received}, where f is the data processing function(s) of the standby component) is suppressed until the master component enters a failure condition, at which time the data output of the standby component is enabled for transmission to a downstream network component. “Failure condition” refers to an operational state of the master component where the master component is unable to process received data in its intended manner.

By utilizing a seamless redundancy component in this manner, it is possible to compensate for component failure and other failover situations without the loss of data or any other impact on data processing throughput and accuracy. This improves network stability, at a very minor cost in terms of infrastructure and processing operational expenditures.

As noted, the standby component is configured to process data in substantially the same manner as the master component. Here, “substantially” doesn't necessarily mean that the two components carry out the same internal operations (although that is a possibility), but rather that given a common data input, the master and standby components produce the same data output but for nominal errors that can be compensated for according to the communication/processing protocols in place in the network 12.

The data output of the standby component may be suppressed in different ways, depending on whether the output of the standby component is connected to the seamless redundancy component. In one embodiment, the output of the standby component is connected to the seamless redundancy component. The seamless redundancy component receives the data output of the standby component, and drops the data output until such a time as the master component enters a failure condition. In another embodiment, the output of the standby component is not connected to the seamless redundancy component. Instead, the seamless redundancy component controls the standby component to disable the standby component's output. In other words, the standby component processes the received data in a normal manner for generating output data, but the actual output data stream is “turned off” or otherwise attenuated.

The seamless redundancy component may be a router or switch that receives a data input (e.g., the data to be processed by the master component) and duplicates the received data for routing to both the master component and to the standby component.

In another embodiment, the seamless redundancy component monitors the master component for determining when the master component enters a failure condition. For example, the master component may generate a “heartbeat” signal indicating whether the master component is operating within desired operational parameters. If the heartbeat signal indicates that the master component is not operating within desired operational parameters, the seamless redundancy component enables the data output of the standby component, and suppresses the data output of the master component, if a data output is present. In particular, when the master component enters a failure condition, it may be the case that it no longer generates a data output, or that it continues to generate an output, which may contain errors or the like. To compensate for the latter case, the system may be configured to drop the data output of the master component when it enters a failure condition, or to control the master component to stop generating an actual signal output.

In another embodiment, the seamless redundancy component is interfaced with a plurality of respective master component-standby component pairs. For example, the seamless redundancy component may include a main input and output, and a plurality of secondary input-output pairs connected to the master components and standby components. For each master component, data received for the master component is routed to both the master component and to its associated standby component, e.g., the data is substantially exactly duplicated for providing to the standby component. Again, the standby components are configured to process the data in the same manner as the master components. For each standby component, the data output of the standby component is suppressed unless and until its respective master component enters a failure condition.

### BRIEF DESCRIPTION OF THE DRAWINGS

The present invention will be better understood from reading the following description of non-limiting embodiments, with reference to the attached drawings, wherein below:

FIG. 1 is a schematic diagram of a seamless redundancy system in an IP network, according to an embodiment of the present invention; and

FIGS. 2-4 are schematic diagrams of alternative embodiments of the seamless redundancy system.

### DETAILED DESCRIPTION

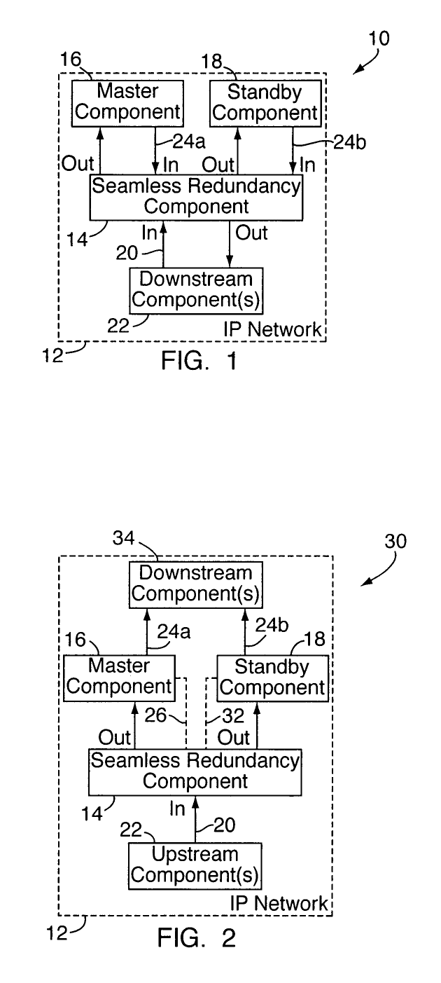

With reference to FIG. 1, a seamless redundancy system 10 is implemented on or as part of an IP (Internet protocol) or other packet data network 12. The system 10 includes a seamless redundancy component 14 interfaced with a master component 16 and a standby component 18. By “component,” it is meant electronic hardware and/or software configured to process data 20 for network communication purposes. Thus, the master component 16 may be, for example, a network gateway, DSLAM or other multiplexer, PDSN (packet data serving node), or the like. The standby component 18 is configured to process data in substantially the same manner as the master component 16. As such, the standby component 18 may be a duplicate of the master component 16, or it may be another type of component configured to perform the same data processing functions as the master component, at least in terms of the data to be handled by the system 10. In other words, the standby component may be configured to perform all the same functions as the master component, or only those for which seamless redundancy is desired in the system 10.

In operation, data 20 is received at the seamless redundancy component 14 from an upstream component 22 in the network 12. (As used herein, “upstream” and “downstream” are arbitrary designations referring to other components in the network from which data is received or to which data is transmitted.) The data 20 is addressed to the master component, or is otherwise intended for processing by the master component 16. As shown in FIG. 1, whereas the data 20 would normally be routed directly to an input terminal of the master component 16, it is instead routed to a “main” input of the seamless redundancy component 14. As the data is received at the seamless redundancy component 14, it is routed to both the master component 16 and to the standby component 18, e.g., the data is duplicated and provided to two secondary outputs of the seamless redundancy component 14, which are respectively connected to input terminals of the master and standby components. The master and standby components 16, 18 process the data 20 in substantially the same manner, thereby producing substantially exactly the same data output 24a, 24b. (As noted above, “substantially” means that given a common data input, the master and standby components produce the same data output but for nominal errors that can be compensated for according to the communication/processing protocols in place in the network 12.) The data outputs 24a, 24b of the master and standby components are received at secondary inputs of the seamless redundancy component 14. The data output 24a of the master component 16 is passed to a main output terminal of the seamless redundancy component 14, for routing to a downstream component 22 in the network 12. The data output 24b of the standby component 18 is suppressed, e.g., the data output 24b is received at the seamless redundancy component 14 and dropped or discarded.

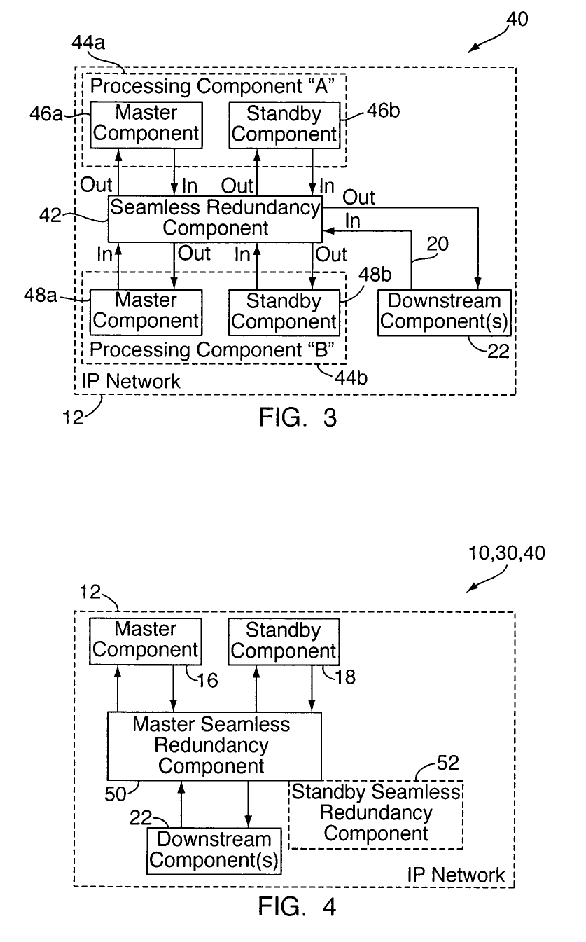

If the master component 16 enters a failure condition, the seamless redundancy component 14 in effect switches between the two data outputs 24a, 24b. Thus, the data output 24a of the master component is suppressed (if necessary), and the data output 24b of the standby component is passed to the main output of the seamless redundancy component 14 for routing to a downstream component 22. “Failure condition” refers to an operational state of the master component where the master component is unable to process received data in its intended, regular, and normal manner. Possible failure conditions include device shutdown, partial shutdown, processing slowdown, and situations involving processing or communication errors that cannot be compensated for by the network 12. Failure conditions may be detected in several manners, depending on the particular characteristics of the master component and on what sort of failure conditions the system 10 is meant to compensate for. For example, the master component 16 may be configured to generate a “heartbeat” signal 26, which is routed to the seamless redundancy component 14 (see FIG. 2). The heartbeat signal 26 indicates whether the master component 16 is operating within desired parameters. Thus, if the heartbeat signal 26 changes to indicate that the master component is no longer operating normally, the seamless redundancy component 14 knows that it has entered a failure condition, and proceeds accordingly by switching to the data output 24b of the standby component 18. Alternatively, failure conditions may be detected by the seamless redundancy component 14 examining the data output 24a of the master component. For example, if the data output 24a stops, or slows down below a designated threshold, or contains errors above a designated threshold level, then the seamless redundancy component 14 switches to the output of the standby component.

Depending on the nature of the failure condition, it may or may not be necessary for the seamless redundancy component 14 to suppress the data output 24a of the master component 16. For example, if the failure condition results in a complete halt of the data output 24a, then there will be no data to suppress. On the other hand, if a data output stream 24a exists despite the failure condition, then the data output 24a is dropped in favor of the data output 24b of the standby component 18.

The seamless redundancy component 14 may be configured to switch back to the master component data output 24a once the master component 16 is no longer in a failure condition. Alternatively, the seamless redundancy component 14 may be configured to only switch back subsequent to receiving a command to that effect, e.g., from a system administrator, administrative module, or the like.

The seamless redundancy component 14 may be a network router or switch that receives a packet data input 20 (e.g., the data to be processed by the master component) and duplicates the received data substantially exactly for routing to both the master component and to the standby component. The router or switch is programmed or otherwise configured, using standard methods, to duplicate the input data 20, and to switch between the two data outputs 42a, 24b if the master component 16 enters a failure condition. Operation of the seamless redundancy component 14 is summarized in the following pseudo-code listing. here, the “Duplicate_Data,” “Route_Out_Data_{—}1,” and “Monitor_Master” subroutines are carried out on an ongoing basis:

| | |
|---|---|
| Duplicate_Data | * Duplicate data received at main input of |
| | seamless redundancy component. |
| Route_Out_Data_1 | * Route duplicated data to secondary outputs of |
| | seamless redundancy component (secondary |
| | outputs are connected to inputs of master and |
| | standby components). |
| Monitor_Master | * Is master component operating within |
| | desired parameters? |

| | |
|---|---|
| YES | |
| { | |
| Route_In_1 | * Route data received at secondary input 1 of |
| | seamless redundancy component (connected |
| | to output of master component) to main |
| | output. |
| Drop_In_2 | * Drop data received at secondary input 2 |
| | (connected to output of standby component). |
| } | |
| ELSE | |
| { | |
| Drop_In_1 | * Drop data received at secondary input 1. |
| Route_In_2 | * Route data received at secondary input 2 to |
| | main output of seamless redundancy |
| | component. |
| } | |

The seamless redundancy component 14 broadcasts all received data packets 20 to both the master and standby components. The master and standby components run in a normal manner, and process the received data 20 in parallel, for generating substantially exactly the same data outputs 24a, 24b. However, the seamless redundancy component 14 only forwards the data output 24a from the master component 16, whereas the data output 24b of the standby component 18 is dropped silently. Since the master and standby components are operating in the same environment, and because the master and standby components are processing the same data in the same way, all network conditions should be reflected in both components very similarly, for generating substantially the same output. When failover or switchover occurs (e.g., the master component enters a failure condition), the seamless redundancy component 14 forwards the data output 24b of the standby component 18 and drops the data output 24a of the master component 16. Thus, the data output of the standby component (e.g., data output=f{data received}, where f is the data processing function(s) of the standby component) is suppressed until the master component enters a failure condition, at which time the data output of the standby component is enabled for transmission to a downstream network component. No output data is lost, and the switchover is processed seamlessly from the master to the standby side.

In terms of control logic, the seamless redundancy component will typically be configured in accordance with the data transportation/transmission protocols in place in the network 12. Generally speaking, data transmission protocols can be divided into two classes: routing-insensitive protocols such as SOAP (Simple Object Access Protocol) and H.323, and routing-sensitive protocols such as SIP (session initiation protocol), which is a commonly used signaling and call setup protocol for IP-based communications. If the seamless redundancy component is intended to support a routing-insensitive protocol, the seamless redundancy component simply duplicates the received IP data packets and sends them to the master and standby components. For example, in the case of SOAP-based communications, the seamless redundancy component 14 has, e.g., an “IP1” address/designation, and is aware of and recognized by external components such as the downstream component 22. The master component 16 has an “IP2” address, and the standby component 18 has an “IP3” address. The downstream component 22 sends a SOAP message to IP1, and the seamless redundancy component 14 duplicates the received packets at IP1 and sends them to IP2 and IP3. The response from IP3 is silently dropped.

In routing-sensitive protocols such as SIP, data transmissions and signaling messages may include route, via, caller-ID, and other routing-sensitive headers or parameters, which will differ at the master and standby components even when processing the same incoming SIP message. If the seamless redundancy component is intended to support SIP or other routing sensitive protocols, the seamless redundancy component is outfitted with an SIP specific logic, e.g., to function like a B2BUA (back-to-back user agent) and fork proxy. (A B2BUA acts as a user agent to both ends of an SIP communication, including handling all SIP signaling between both ends of the communication and maintaining a state of the communication.) Here, for incoming SIP messages intended for a master component, the seamless redundancy component forks the SIP messages to the master and standby components, whereas the SIP messages received from the standby component are silently dropped. For example, when the seamless redundancy component 14 receives an SIP request from the downstream component 22, it will fork two SIP requests and send them to the master component 16 and to the standby component 18 with new via, route, caller-ID, etc. The response from the standby component 18 is dropped silently. Routers and switches can be configured to function as a B2BUA and fork proxy using standard programming methods, and pre-existing programs are available for most routers on the Internet.

The system 10 may be implemented as part of any type of packet data network 12, such as those using IP-based communications or otherwise. Examples include wireless networks (e.g., cellular telephone networks), IMS (IP multimedia subsystem) networks, the Internet, local area networks, and the like. The system 10 is applicable for use with networks that use different communication protocols, although it is particularly well suited for use in the context of UDP (User Datagram Protocol) communications. (UDP is a communications protocol for exchanging messages between computers in a network that uses the Internet protocol.)

FIG. 2 shows a second embodiment of the system 30, for the case where the master and standby components 16, 18 do not have the same inputs and outputs as the seamless redundancy component 14. In particular, in FIG. 1, the master and standby components have the same inputs and outputs as the seamless redundancy component 14, so that the seamless redundancy component 14 is in effect transparently disposed in the I/O (input/output) signal path of the master and standby components. However, in some instances it may not be possible to route the outputs of the standby and master components through the seamless redundancy component 14. Thus, as shown in FIG. 2, the seamless redundancy component 14 is configured to control the standby component 18 for outputting data. In particular, data 20 is received from an upstream component 22 at the primary input of the seamless redundancy component 14. The data 20 is duplicated and passed through the secondary outputs of the seamless redundancy component 14, for routing to the master component 16 and to the standby component 18. The seamless redundancy component 14 monitors the master component 16 through a heartbeat signal 26 or similar mechanism. In addition, the seamless redundancy component 14 is connected to the standby component 18 thorough a control line or bus 32 or the like. In operation, the master and standby components process the data 20 in an ongoing manner. As long as the master component 16 is operating normally, its data output 24a is routed to a downstream network component 34. Over the control line 32, the standby component 18 is instructed to disable its data output 24b. However, if the master component 16 enters a failure condition, the seamless redundancy component 14 instructs the master component 16 to stop outputting data. Concurrently, the seamless redundancy component 14 generates a control signal over the control line 32, instructing the standby component 18 to enable its data output 24b. In this manner, the seamless redundancy component 14 switches between the master and standby components in a seamless manner.

It should be noted that the system 10, 30 may not work in situations where both the master and standby components have segmentation violation and are down at the same time. However, compensation mechanisms may be incorporated into the system 10, 30 for accounting for such circumstances.

FIG. 3 shows another embodiment of the seamless redundancy system 40. Here, a seamless redundancy component 42 includes a main input/output (connected to downstream/upstream components 22) and a plurality of secondary input/outputs. The secondary input/outputs are connected to a plurality of processing components, e.g., a processing component “A” 44a and a processing component “B” 44b. (Additional processing components may be attached to the seamless redundancy component 42, depending on its capacity.) Each processing component 44a, 44b includes a master component 46a, 48a and a standby component 46b, 48b. The master component performs the designated processing function(s) of the processing component, and the standby component performs the same function(s) for backup/failover purposes, as discussed above. If there is a switchover at the seamless redundancy component 42, e.g., if one of the master components 46a enters a failure condition, the data output of the master component 46a is suppressed (if necessary), and the data output of the standby component is routed to the downstream components 22.

As shown in FIG. 3, there are two components 44a, 44b that share the seamless redundancy component 42. If there is a switchover at one component, the other component will not be impacted. With the seamless redundancy component 42, all processing components 44a, 44b interfaced therewith are able to use the same redundancy mechanism, thereby obviating the need for each processing component to have its own redundancy mechanism. This reduced the overall processing load of the system, and also reduces development and system implementation costs.

The seamless redundancy component 42 in FIG. 3 is configured similarly to the seamless redundancy component 14 shown in FIGS. 1 and 2. However, the seamless redundancy component 42 includes more secondary inputs/outputs, and is configured to route received data 20 to the appropriate master/standby component pair, depending on how the received data 20 is addressed and/or on the contents of the received data. Example functionality is as follows:

| | |
|---|---|
| Identify_Data(Return X) | * As data is received at the main input of the |
| | seamless redundancy component determine to |
| | which master component “X” the data should |
| | be routed. |

| | |
|---|---|
| Duplicate_Data | * Duplicate data received at main input. |
| Route_Out_Data_X | * Route duplicated data to secondary outputs of |
| | seamless redundancy component that are |
| | connected to inputs of master component X and |
| | its associated standby component. |
| Monitor_Master_X | * Is master component X operating within |
| | desired parameters? |

| | |
|---|---|
| YES | |
| { | |
| Route_In_X1 | * Route data received at secondary input X1 of |
| | seamless redundancy component (which is |
| | connected to output of X) to main output. |
| Drop_In_X2 | * Drop data received at secondary input X2 |
| | (which is connected to output of standby |
| | component associated with X). |
| } | |
| ELSE | |
| { | |
| Drop_In_X1 | * Drop data received at secondary input X1. |
| Route_In_X2 | * Route data received at secondary input X2 to |
| | main output of seamless redundancy |
| | component. |
| } | |

As with other network components, the seamless redundancy component is subject to entering an error condition, failure condition, or the like. In such situations, when the seamless redundancy component is down, it might block all the master/standby components to which it is connected. As such, the seamless redundancy component could be configured for a switchover or failover operation, for maintaining a high level of availability and stability in the network. As shown in FIG. 4, for example, the seamless redundancy component could itself be provided with a redundancy mechanism. Here, the system includes a master seamless redundancy component 50 and a standby seamless redundancy component 52. The master seamless redundancy component 50 functions similarly to the seamless redundancy components described above. The standby seamless redundancy component 52 functions in the same manner as the master component 50. In operation, the master component 50 carries out the processing functions described above, including tracking the status of the master/standby components. If the master component 50 enters a failure condition, it switches over to the standby component 52, which operates in its place. As part of the switchover process, the master component 50 communicates the master/standby status information to the standby component 52. Alternatively, the standby component 52 can maintain status information on an ongoing basis.

For seamless redundancy component switchover, the system may utilize floating IP addresses. “Floating” IP address refers to a unique IP address, to which data may be addressed/routed, but which is reassigned between components on an as-needed basis, for seamless redundancy/failover purposes. Because the seamless redundancy component 50 does not have to store data, and because it only carries out a packet forwarding function, data synchronization is not needed between the master and standby components 50, 52. If there is a switchover at the seamless redundancy component 50, e.g., if the master component 50 enters a failure condition, the floating IP address of the master component 50 is deactivated, and activated at the standby component 52. Subsequently, the data output of the standby component 52 is routed to the downstream components 22.

Although the input/output communication pathways of the system 10, 30, 40 are shown in the figures as comprising single lines, it should be appreciated that the communication pathways may include multi-line conductors, busses, or the like, in addition to single lines/conductors. Also, although the system has been shown as including multiple secondary input/outputs, etc., a common bus mechanism could instead be used.

Since certain changes may be made in the above-described system for seamless redundancy in an IP communication network, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method of processing data in a network, said method comprising:
routing data received for a master component to both the master component and to a standby component, wherein the standby component is configured to process the data in substantially the same manner as the master component; and
suppressing a data output of the standby component until the master component enters a failure condition.

2. The method of claim 1 further comprising:
upon said master component entering a failure condition, switching from a data output of the master component to the data output of the standby component; and
routing the data output of the standby component to a downstream network entity.

3. The method of claim 1 further comprising:
receiving the data output of the standby component and a data output of the master component;
routing the data output of the master component to a downstream network entity; and, upon the master component entering a failure condition,
suppressing the data output of the master component, wherein the data output of the standby component is routed to the downstream network entity.

4. The method of claim 1 further comprising:
controlling the standby component to drop its data output; and, upon the master component entering a failure condition,
controlling the standby component to enable its data output for transmission to a downstream network entity.

5. The method of claim 1 wherein the standby component is controlled to drop its data output until the master component enters a failure condition, at which time the data output of the standby component is enabled for transmission to a downstream network entity.

6. The method of claim 1 further comprising:
receiving second data for a plurality of second master components;
routing the second data both to the second master components and to a plurality of second standby components respectively associated with the second master components, wherein the second data is received and routed at a single seamless redundancy component operably connected to the second master and standby components, and wherein the second standby components are respectively configured to process the second data in the same manner as the second master components; and
for each of the second standby components, suppressing a second data output of the second standby component until its respective master component enters a failure condition.

7. The method of claim 1 further comprising:
monitoring the master component to detect when the master component enters a failure condition.

8. The method of claim 7 further comprising:
upon said master component entering a failure condition, switching from a data output of the master component to the data output of the standby component; and
routing the data output of the standby component to a downstream network entity.

9. The method of claim 8 further comprising:
subsequent to switching from the data output of the master component to the data output of the standby component, suppressing the data output of the master component.

10. The method of claim 7 further comprising:
receiving the data output of the standby component and a data output of the master component;
routing the data output of the master component to a downstream network entity; and, upon the master component entering a failure condition,
suppressing the data output of the master component, and routing the data output of the standby component to the downstream network entity.

11. The method of claim 7 further comprising:
controlling the standby component to drop its data output; and, upon the master component entering a failure condition,
controlling the standby component to enable its data output for transmission of the data output to a downstream network entity.

12. The method of claim 7 wherein the standby component is controlled to drop its data output until the master component enters a failure condition, at which point the data output of the standby component is enabled for transmission to a downstream network entity.

13. The method of claim 1 wherein:
said routing step is carried out at a master seamless redundancy component interfaced with the master and standby components; and
the method further comprises, if the master seamless redundancy component enters a failure condition, switching from the master seamless redundancy component to a standby seamless redundancy component for subsequently carrying out said routing and suppression steps.

14. The method of claim 13 further comprising:
upon the master seamless redundancy component entering a failure condition, transferring state information to the standby seamless redundancy component, said state information relating to operational conditions of the master and standby components.

15. A method of processing data in a network, said method comprising:
routing data received for a plurality of master components to both the master components and to a plurality of standby components respectively associated with the master components, wherein each standby component is configured to process the data in the substantially same manner as its respective master component; and,
for each standby component, suppressing a data output of the standby component until its respective master component enters a failure condition;
wherein the data is received and routed at a single seamless redundancy component operably connected to the master and standby components.

16. The method of claim 15 further comprising:
upon any of said master components entering a failure condition, switching from a data output of the master component to the data output of its respective standby component; and
routing the data output of the standby component to a downstream network entity.

17. The method of claim 15 further comprising:
receiving, at the seamless redundancy component, data outputs of the standby components and data outputs of the master components;
routing the data outputs of the master components to one or more downstream network entities; and, upon any of the master components entering a failure condition,
suppressing the data output of the master component, and routing the data output of the master component's respective standby component to a downstream network entity.

18. A method of processing data in a network, said method comprising:
receiving data for a master component at a seamless redundancy component;
substantially concurrently routing a substantially exact copy of the data from the seamless redundancy component to the master component and to a standby component, wherein the standby and master components are configured to produce substantially the same data outputs based on the received data;
determining at the seamless redundancy component whether the master component has entered a failure condition; and, if so,
enabling the data output of the standby component, for said data output to be routed to a downstream network component in lieu of the data output of the master component.

19. The method of claim 18 further comprising:
controlling the standby component for enabling the data output thereof when the master component enters a failure condition.

20. The method of claim 18 wherein:
the data outputs of the standby component and master component are routed to the seamless redundancy component; and
the method further comprises dropping the data output of the standby component unless it is determined that the master component has entered a failure condition.
